(19) United States
(12) Patent Application Publication
(10) Pub. No.: US 2011/0221640 A1
(43) Pub. Date: Sep. 15, 2011

(54) ANTENNA DEVICE AND MOTOR VEHICLE HAVING AN ANTENNA DEVICE

(75) Inventor: Harald Huber, Hildesheim (DE)

(73) Assignee: BLAUPUNKT ANTENNA SYSTEMS GMBH & CO. KG

(21) Appl. No.: 13/128,819

(22) PCT Filed: Nov. 11, 2009
(86) PCT No.: PCT/EP09/64968

§ 371 Date: May 31, 2011

(30) Foreign Application Priority Data
Nov. 11, 2008 (DE) 10 2008 043 632.1

(51) Int. Cl. H01Q 1/32

(52) U.S. Cl. 343/713

(57) ABSTRACT

The invention relates to an antenna device (1), in particular a roof antenna device (19), for a motor vehicle, having at least one antenna (6) and at least one electronic assembly (7). In this case, provision is made for the antenna (6) and the electronic assembly (7) to be arranged in a water-tight inner housing (2) and for a visible housing (5) to cover the inner housing (2). The invention also relates to a motor vehicle having an antenna device (1).

The invention relates to an antenna device, in particular a roof antenna device, for a motor vehicle, having at least one antenna and at least one electronic assembly.

### PRIOR ART

Antenna devices of the type mentioned at the outset are known from the prior art. For example, WO 2006/034915 A1 describes an antenna housing in which a cap encloses, at least in portions, a main body which faces a mounting surface. The main body comprises electronics of the antenna device, for example the antenna and the electronic assembly. The main body is usually a zinc die-cast part to which a plurality of receiving units, for example antennae and associated electronic assemblies, are screwed. The cap is then connected to the zinc die-cast part, for example by screwing or, as described in WO 2006/034915 A1, using a breaking seam on a terminal edge of the main body. In this case, the main body is protected from environmental influences by the cap, or the cap prevents moisture, for example, from reaching the main body. Adaptation to the motor vehicle, for example to the roof of the motor vehicle, is also achieved by means of the cap and the main body. In particular, specific gap sizes between the motor vehicle and the antenna device are to be maintained in order to achieve a perfect visual appearance of the antenna device. Since two components, i.e. the cap and the main body, are required for adaptation to the motor vehicle, color design in the series production process and storage/logistics are complex.

### DISCLOSURE OF THE INVENTION

In contrast, the antenna device having the features mentioned in claim 1 has the advantage that the number of parts to be assembled of the antenna device can be reduced, no screw connection is required and the quality can also be improved at the same time, with simplified logistics. According to the invention, this is achieved in that the antenna and the electronic assembly are arranged in a watertight inner housing and the inner housing is covered by a visible housing. The inner housing substantially corresponds to the above-mentioned main body, in that the electronics of the antenna device, in the form of the antenna and the electronic assembly, are arranged on the inner housing or in the inner housing. In contrast to the main body, however, the antenna and the electronic assembly are not merely fastened to the inner housing but are arranged inside the inner housing, which is also formed so as to be watertight. In this case, the antenna and the electronic assembly can also be arranged inside the inner housing only in part. For example, it is conceivable for at least one region of the antenna and/or the electronic assembly to be provided in a surface and/or in the material of the inner housing. In this way, (weather-)sensitive electronics can be arranged in the inner housing so as to be protected against water, while externally arranged elements can be protected by a paint, for example. In order to achieve a good visual appearance, the inner housing is covered by a visible housing. The visible housing substantially corresponds to the above-mentioned cap. However, it does not have a sealing function but rather serves merely to hide the inner housing and maintain gap measurements. In this way, the visible housing can be adapted to the motor vehicle in a simple manner, thus considerably simplifying the color design in the series production process and also storage/logistics, since this adaptation can now be carried out merely via one part, namely the visible housing. Since the inner housing is watertight, no sealing unit is required between said inner housing and the visible housing. Likewise, there is no need for a rigid connection between the inner housing and the visible housing, as a result of which the system is free from forces and no stresses develop between the inner housing and the visible housing. These stresses usually occur when the main body is screwed to the cap in a watertight manner.

According to one embodiment, at least two components of the inner housing, which consists of at least two components, are screwed together to produce a secure connection between them. As a result, only slight modifications to previous production processes are required.

A development of the invention provides that the inner housing is formed in one piece. By forming the inner housing in one piece, said inner housing can be produced in a simple and watertight manner. Since no releasable connections are provided on the inner housing, the antenna and the electronic assembly which are arranged in the inner housing are effectively protected against environmental influences, in particular the entry of moisture.

According to one embodiment, the inner housing is formed in one piece by welding, or connecting in another permanent manner, at least two components, for example a base part and a cover part. Alternatively or additionally, a one-piece design is achieved by using MID (Molded Interconnect Device) technology, as explained below.

A development of the invention provides that the antenna and/or the electronic assembly are enclosed, at least in regions, by the inner housing material. It is thus not necessary for the antenna and/or the electronic assembly to be arranged completely inside the inner housing. It can also be provided that they are arranged inside the inner housing material in regions. For example, the antenna and/or the electronic assembly can be completely molded in the inner housing material. It is also conceivable for the inner housing to be completely filled with the inner housing material. According to another preferred embodiment, the antenna and/or at least a part of the electronic assembly are molded, at least in part, in at least one region of the wall of the inner housing.

A development of the invention provides that the visible housing can be connected to the inner housing, in particular by a snap action or otherwise by locking, screwing, welding, stamping, adhesive bonding or by other permanent, releasable or non-releasable connections. A simple connection between the visible housing and the inner housing is thus provided, without causing stresses in the visible housing or in the inner housing, as known from the prior art. This connection can preferably be achieved by a snap or clip action. Either the visible housing or the inner housing therefore comprises a retaining element which is connected to the respective other housing part by positive locking. In this case, the retaining element is preferably formed so as to be resiliently deformable, in such a way that the visible housing can be separated from the inner housing again without damage after having been attached thereto.

A development of the invention provides that the inner housing comprises a base part and a cover part, which in particular are integrally interconnected. The antenna and the electronic assembly can thus be arranged on the base part or the cover part. These are then interconnected in such a way that the inner housing is formed in one piece. After production of the antenna device or the inner housing, the inner housing is thus present in one piece. ‘in one piece’ means, in particular, that a permanent, non-releasable connection which cannot be reversed in a non-destructive manner has been carried out. In particular, this connection can be carried out by laser welding, ultrasonic welding, stamping, heating, adhesive bonding or combinations thereof.

A development of the invention provides that the base part and the cover part are welded together, in particular by laser welding and/or ultrasonic welding. The base part and the cover part can be connected to form the one-piece watertight inner housing in a particularly advantageous manner by welding them together. In this case, a laser welding process and/or an ultrasonic welding process, for example, can be used. Alternatively or additionally, further connection methods can be used, such as stamping, in order to further increase the strength and durability of the connection.

A development of the invention provides that the antenna and/or the electronic assembly are formed, at least in regions, by MID technology. The abbreviation MID stands for Molded Interconnect Devices. In MID technology, metal strip conductors are placed on injection-molded plastics material carriers. In particular, methods such as two-component injection molding, stamping, in particular hot stamping, mask exposure methods, film back injection molding and laser structuring can be used in this context. The antenna and/or the electronic assembly can be arranged in the inner housing or formed in the inner housing material in a simple manner by the MID method. For example, at least a part of the antenna can be formed in a recess in the surface of the inner housing and simultaneously connected to the electronic assembly, which is located in the inner housing, for example. In this way, non-sensitive parts of the antenna and/or the electronic assembly can be provided on the upper face of the inner housing, while further regions of the antenna and/or the electronic assembly are arranged inside the inner housing or in the inner housing material. A construction which is compact and at the same time resistant to environmental influences is thus provided. The components thus produced are also easier to dispose of, since components produced by MID technology can be recycled.

The inner housing and also the visible housing can have any desired contours and/or shapes, i.e. can form what are known as free formed surfaces. This is made possible by the use of MID technology in particular, whereby conductor structures having any desired shape can be produced more easily. To a large extent, the dimensions can also be as desired, in such a way that adaptation to different types of vehicle and antenna is possible.

On the one hand, the design of the inner housing in terms of contour and/or shape and/or dimensions is based in particular on the type of antenna to be used and the electronic components required therefor. On the other hand, the external configuration is based in particular on the visible housing to be used which is provided for a vehicle type.

The design of the visible housing in the inner region is based in particular on the inner housing used and possibly on the antenna elements or electronic components applied to the outer face thereof.

The styling of the outer face of the visible housing is based in particular on the type of vehicle used and on other technical requirements, such as aerodynamic styling.

A development of the invention provides a sealing element which is arranged between the surface of the motor vehicle and the inner housing. In order to provide a connection from the antenna or the electronic assembly into the motor vehicle, an opening is usually provided in the side of the inner housing facing the motor vehicle. The sealing element is provided so that no moisture can penetrate the inner housing through this opening. This sealing element is arranged between the surface of the motor vehicle and the inner housing in such a way that it is not possible for the electronic assembly or the antenna to be impaired by environmental influences through the opening. In particular, a ring made of resilient material such as silicone or rubber is provided for this purpose.

A development of the invention provides that the antenna is a GSM antenna, a GPS antenna and/or an SDARS antenna. The antenna or the electronic assembly can be configured for a plurality of different applications. For example, a GSM emitter is provided which in MID technology is arranged on the inner housing, the inner housing material being plated through and a connection into the inner housing thus being possible. Likewise, the antenna can be a GPS patch and/or an SDARS patch which is arranged in the inner housing or applied to base part. Because the external and internal surfaces of the inner housing can be formed as free formed surfaces, i.e. can have any desired contours and shapes, any desired antenna shapes, for example patch antennae or rod antennae, can be arranged in the inner housing. The invention further relates to a motor vehicle having an antenna device according to the above configurations.

The invention further relates to an inner housing in which the antenna device and the electronic assembly are arranged. In this case, the antenna device and/or the electronic assembly can in particular be enclosed in the inner housing, at least in part. This is achieved in particular by MID technology.

The invention further relates to a visible housing which is formed in such a way that an inner housing, in which the antenna device and/or an electronic assembly are arranged, can be arranged inside said visible housing.

In particular, the visible housing can be connected to the inner housing. This is possible in particular via a snap or locking device part on the visible housing, which snap or locking device part corresponds to a part of the snap or locking device attached to the inner housing. In particular, a resiliently deformable retaining element, which can be connected to the inner housing by positive locking, is thus provided on the visible housing. Alternatively or additionally, the visible housing is formed in such a way that it connects to a retaining element on the inner housing.

According to other embodiments, the visible housing can be connected to the inner housing by screwing, welding or stamping.

In particular, an external shape and/or external dimensions of the visible housing is/are standardized for different types of vehicle, in such a way that said housing does not need to be adapted for each individual type of vehicle. The internal shape and/or the internal dimensions of the visible housing is/are adapted to the different types of antenna, in such a way that standardization according to antenna type is also provided.

Production can thus be organized in a more efficient manner.

The invention is described hereinafter with reference to the embodiments shown in the drawings, without limiting the invention. In the drawings:

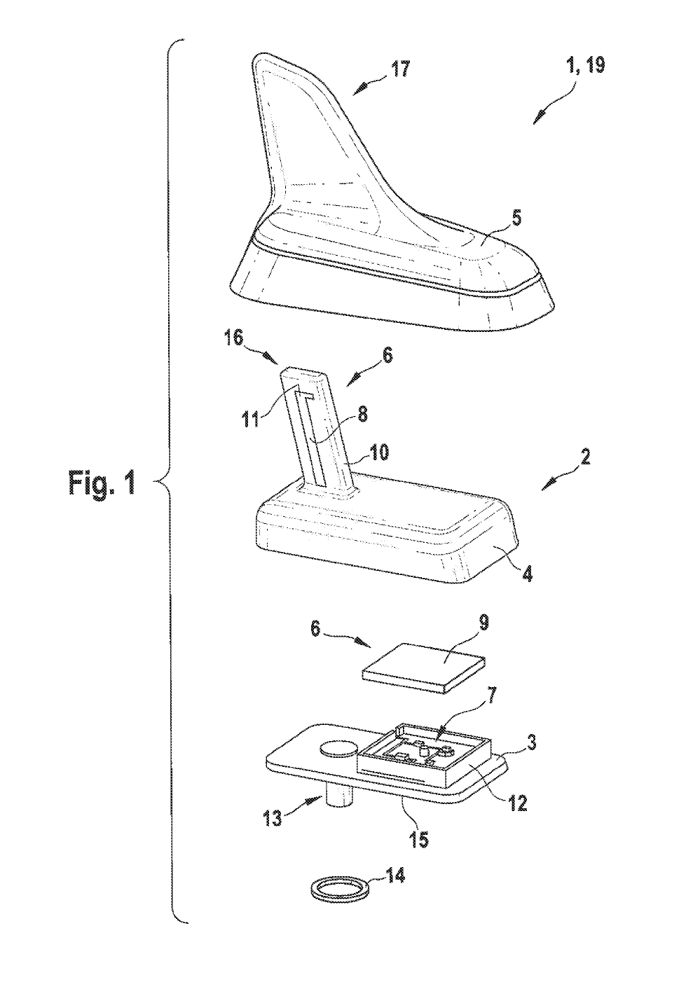

FIG. 1 is a schematic exploded view of the antenna device comprising a plurality of antennae and electronic components which are arranged in a watertight inner housing, the inner housing being covered by a visible housing, and

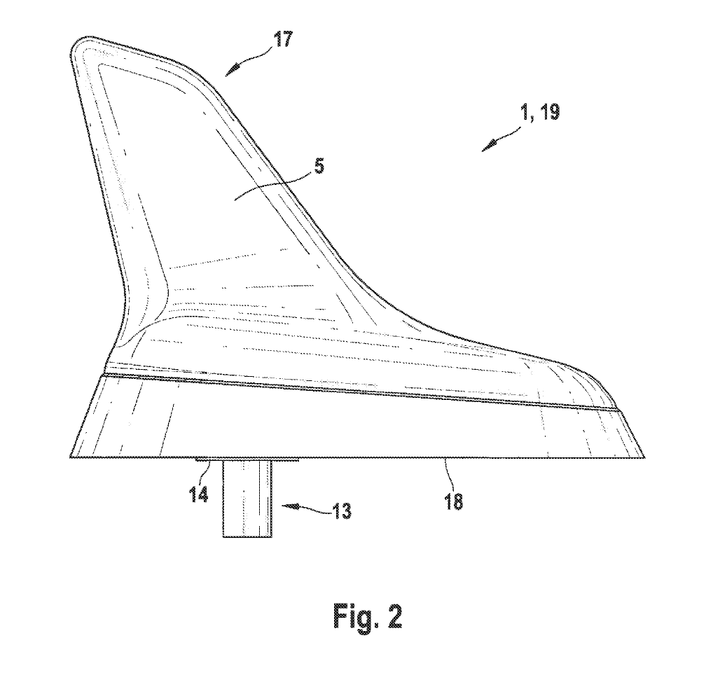

FIG. 2 is a side view of the fully assembled antenna device.

### EMBODIMENTS OF THE INVENTION

FIG. 1 is an exploded view of an antenna device 1 comprising a watertight inner housing 2 which is made up of a base part 3 and a cover part 4. A visible housing 5 is provided over the inner housing. This visible housing is used to hide the inner housing and to set gap measurements from a motor vehicle (not shown). The finished watertight inner housing 2 is produced by connecting, in particular welding, the base part 3 to the cover part 4. The embodiment shown in FIG. 1 comprises two antennae 6 and an electronic assembly 7. One of the antennae 6 is formed as a GSM emitter 8, the other as a GPS patch 9. An SDARS patch can also be provided. The GSM emitter 8 is formed in the inner housing material 10 by MID technology. For this purpose, the cover part 4 comprises a recess in the region of the GSM emitter 8, into which recess the GSM emitter 8 is inserted. The GSM emitter 8 thus forms part of a surface 11 of the inner housing 2. The electronic assembly 7 is also constructed according to MID technology and is provided on the base part 3. The GPS patch 9 is applied to a casing 12 of the electronic assembly 7. Once the base part 3 and the cover part 4 have been welded to form the inner housing 2, the electronic assembly 7 and the GPS patch are thus located inside the inner housing 2 and are thus protected from environmental influences. In contrast, the non-weather-sensitive GSM emitter 8 or the non-weather-sensitive outer part thereof forms part of the surface 11. The electronic assembly 7, the GSM emitter 8 and/or the GSM patch 9 can be connected to the motor vehicle via a connecting piece 13. For this purpose, the connecting piece 13 is constructed in the form of a hollow cylinder, in such a way that cable connections can be guided from the motor vehicle into the inner housing 2. In order to prevent moisture from entering the interior of the inner housing 2 through the connecting piece 13, a sealing element 13 is provided which is arranged around the connecting piece 13. In this case, it is located between the inner housing 2 and the motor vehicle. It is therefore not necessary for an entire lower face 15 of the base part 3 to be sealed to the motor vehicle, since only the connecting piece 13 needs to be protected against the entry of water. The fastening of the inner housing 2 can also be provided by the connecting piece 13. Owing to the characteristic of the GSM emitter 8, the inner housing 2 has a protrusion 16. The visible housing must therefore also follow this shape. Good visual and streamlined properties are particularly important in this context. In this case, a fin 17 is produced which gives the visible housing 5 a characteristic shape. The visible housing 5 is adapted to the motor vehicle in terms of color and also produces a clean gap measurement therefrom. The visible housing 5 can be connected to the inner housing 2, for example by a snap action. For this purpose, retaining elements (not shown here) are provided.

FIG. 2 is a side view of the fully assembled antenna device 1. The visible housing 5 comprising the fin 17, the connecting piece 13 and the sealing element 14 can be seen. In the example shown, the inner housing 2 is arranged completely inside the visible housing 5.

When the antenna device 1 is mounted on the motor vehicle, the sealing element 14 is compressed in such a way that a lower edge 18 of the visible housing 15 can be connected to the motor vehicle to produce a defined gap measurement.

The antenna device 1 can be used particularly advantageously as a roof antenna device 19, as shown in FIGS. 1 and 2.

1. Antenna device (1), in particular a roof antenna device (19), for a motor vehicle, having at least one antenna (6) and at least one electronic assembly (7), characterized in that the antenna (6) and the electronic assembly (7) are arranged in a watertight inner housing (2) and the inner housing (2) is covered by a visible housing (5).

2. Antenna device according to claim 1, characterized in that the inner housing (2) is formed in one piece.

3. Antenna device according to either of the preceding claims, characterized in that the antenna (6) and/or the electronic assembly (7) is/are enclosed by the inner housing material (10), at least in regions.

4. Antenna device according to any one of the preceding claims, characterized in that the visible housing (5) can be connected to the inner housing (2), in particular by a snap action.

5. Antenna device according to any one of the preceding claims, characterized in that the inner housing (2) comprises a base part (3) and a cover part (4) which are interconnected, in particular integrally.

6. Antenna device according to any one of the preceding claims, characterized in that the base part (3) and the cover part (4) are welded to one another, in particular by laser welding.

7. Antenna device according to any one of the preceding claims, characterized in that the antenna (6) and/or the electronic assembly (7) is/are formed by MID technology, at least in regions.

8. Antenna device according to any one of the preceding claims, characterized by a sealing element (14) which is arranged between the surface of the motor vehicle and the inner housing (2).

9. Antenna device according to any one of the preceding claims, characterized in that the antenna (6) is a GSM antenna (8), a GPS antenna (9) and/or an SDARS antenna.

10. Inner housing (2) for an antenna device (1), comprising an antenna (6) and an electronic assembly (7) which are arranged in the watertight inner housing (2), at least in part.

11. Inner housing (2) according to claim 10, in which the antenna (6) and/or the electronic assembly (7) is/are enclosed in the inner housing material, at least in regions.

12. Inner housing (2) according to either claim 10 or claim 11, in which the antenna (6) and/or the electronic assembly (7) is/are formed by MID technology, at least in regions.

13. Visible housing (5) for an antenna device (1), which visible housing is formed in such a way that an inner housing (2) according to any one of claims 10 to 12 comprising an antenna (6) and an electronic assembly (7) can be arranged therein and the visible housing (5) can be connected to said inner housing, in particular by a snap action, locking, screwing welding, adhesive bonding or stamping.

14. Motor vehicle comprising an antenna device (1) according to one or more of the preceding claims.
